(19) United States
(12) Patent Application Publication
(10) Pub. No.: US 2026/0249622 A1
(43) Pub. Date: Aug. 27, 2026

(54) INKJET PRINTING APPARATUS

(71) Applicant: SCREEN Holdings Co., Ltd., Kyoto (JP)

(72) Inventors: Yoshihiro MASUYA, Kyoto-shi (JP); Takashi KURODA, Kyoto-shi (JP); Kazuma TANI, Kyoto-shi (JP); Yasuharu MORI, Kyoto-shi (JP)

(21) Appl. No.: 19/447,059

(22) Filed: Jan. 13, 2026

(30) Foreign Application Priority Data
Feb. 27, 2025 (JP) 2025-030599

(51) Int. Cl. B41J 11/00; B41J 2/21; B41J 29/393

(52) U.S. Cl. CPC B41J 11/00212; B41J 2/2103; B41J 11/00216; B41J 11/00218; B41J 29/393; B41J 2029/3935

(57) ABSTRACT

An inkjet printing apparatus comprises: a transport unit transporting a base material in a transport direction; an inkjet unit ejecting inks in a plurality of colors to the base material; a printing controller controlling the inkjet unit based on image data to print an objective image expressed by the image data on the base material; a drying unit downstream of the inkjet unit in the transport direction, applying infrared rays to dry ink on the base material; a temperature sensor measuring temperature at a measurement target region in the base material subjected to infrared rays; and a monitoring part monitoring the measured temperature. The measurement target region has infrared absorbance exceeding the image data's average infrared absorbance value.

### RELATED APPLICATIONS

This application claims the benefit of Japanese Application No. 2025-030599, filed on Feb. 27, 2025, the disclosure of which is incorporated by reference herein.

### BACKGROUND OF THE INVENTION

### Field of the Invention

A subject matter disclosed in this specification relates to an inkjet printing apparatus.

### Description of the Background Art

An inkjet printing apparatus conventionally known performs printing by ejecting ink to a surface of an elongated strip-shaped base material while transporting the base material using a plurality of transport rollers, etc. Such an inkjet printing apparatus is provided with a drying device for drying the ink while transporting the continuous base material (Japanese Patent Application Laid-Open No. 2023-116266, for example).

### SUMMARY OF THE INVENTION

### Technical Problem

It is possible to perform the drying efficiently by using a heat source such as a carbon heater as the drying device from which a comparatively high-power infrared ray (or far-infrared ray) is output. However, if the power of the infrared ray becomes excessive, the base material might be damaged due to excess of a temperature at the base material over a heatproof temperature. Moreover, if release paper is joined with an adhesive, for example, the release paper might be floated and fold lines might occur due to excess of the temperature of the adhesive over a heatproof temperature.

The base material is coated with ink during printing. Depending on the color or type of the ink, however, an infrared ray is absorbed more in a coated portion than in an uncoated portion, so that the coated pat is likely to be placed under a high temperature. As a result, a high-temperature anomaly is likely to occur in the printed portion. This creates a need for a technique allowing a high-temperature anomaly in the printed portion to be detected properly.

The present invention is intended to provide a technique allowing a high-temperature anomaly in a printed portion to be detected properly.

### Solution to Problem

To solve the above problem, a first aspect is intended for an inkjet printing apparatus comprising: a transport unit that transports a base material in a transport direction; an inkjet unit that ejects inks in a plurality of colors to the base material being transported by the transport unit; a printing controller that controls the inkjet unit on the basis of image data to print an objective image expressed by the image data on the base material; a drying unit located on a downstream side of the transport direction with respect to the inkjet unit, the drying unit applying an infrared ray to the base material to dry an ink ejected to the base material; a temperature sensor that measures a temperature at a measurement target region in the base material applied with the infrared ray; and a monitoring part that monitors the temperature at the measurement target region measured by the temperature sensor. The measurement target region for the temperature sensor has infrared absorbance greater than an average value of infrared absorbance expressed by the image data.

In the inkjet printing apparatus according to the first aspect, by measuring a temperature at a region likely to be placed under a high temperature, it becomes possible to detect a high-temperature anomaly at a printed portion of the objective image properly.

According to a second aspect, in the inkjet printing apparatus according to the first aspect, the printing controller controls the inkjet unit to print a patch image in the measurement target region. The patch image is an image where infrared absorbance is greater than the average value of the infrared absorbance expressed by the image data. The temperature sensor measures a temperature at the measurement target region defined in the base material and printed with the patch image.

In the inkjet printing apparatus according to the second aspect, it is possible to detect a high-temperature anomaly at a printed portion of the objective image on the basis of measurement result about a temperature at the patch image.

According to a third aspect, in the inkjet printing apparatus according to the second aspect, the printing controller controls the inkjet unit to print the patch image using a color resulting in infrared absorbance equal to or greater than a maximum value of the infrared absorbance expressed by the image data.

In the inkjet printing apparatus according to the third aspect, infrared absorbance in the patch image becomes equal to or greater than maximum infrared absorbance in the objective image. Thus, it is possible to detect a high-temperature anomaly at a printed portion of the objective image properly through measurement of a temperature at the patch image.

According to a fourth aspect, the inkjet printing apparatus according to the second or third aspect further comprises: a storage part storing correlation information showing a correlation between ink concentrations in the plurality of colors and infrared absorbance; and an absorbance analyzer that analyzes the infrared absorbance expressed by the image data using the correlation information.

In the inkjet printing apparatus according to the fourth aspect, by analyzing the infrared absorbance expressed by the image data using the correlation information, it becomes possible to set a color of the patch image properly.

According to a fifth aspect, in the inkjet printing apparatus according to any one of the second to fourth aspects, the printing controller prints the patch image in black in the measurement target region.

In the inkjet printing apparatus according to the fifth aspect, by measuring a temperature at the patch image in black resulting in the maximum infrared absorbance, it becomes possible to detect a high-temperature anomaly at a printed portion of the objective image properly.

According to a sixth aspect, in the inkjet printing apparatus according to any one of the second to fifth aspects, the printing controller controls the inkjet unit to print the patch image on an upstream side of the transport direction with respect to the objective image.

In the inkjet printing apparatus according to the sixth aspect, it is possible to detect a high-temperature anomaly at a printed portion of the objective image before it occurs. Thus, action can be taken in response to a high-temperature anomaly.

According to a seventh aspect, the inkjet printing apparatus according to any one of the first to sixth aspects further comprises a sensor mover that moves the temperature sensor in a width direction in such a way as to cause the temperature sensor to measure a temperature at a portion of the objective image expressed by the image data where infrared absorbance is greater than the average value of the infrared absorbance.

In the inkjet printing apparatus according to the seventh aspect, as a temperature is measured directly at a printed portion of the objective image likely to be placed under a high temperature, it is possible to detect a high-temperature anomaly at the objective image properly.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows the configuration of an inkjet printing apparatus according to a preferred embodiment;

FIG. 2 shows a lower surface of a head unit;

FIG. 3 is a top view schematically showing a part of the inkjet printing apparatus;

FIG. 4 is a block diagram showing electrical connection between a controller and a control target;

FIG. 5 is a top view schematically showing a base material printed with images;

FIG. 6 is a front view schematically showing a section of the base material taken along a position A-A in FIG. 5;

FIG. 7 conceptually shows an example of correlation information showing a correlation between an ink color and absorbance;

FIG. 8 is a view for explaining exemplary setting of a distance between an objective image and a patch image;

FIG. 9 is a top view showing a modification of a print position for the patch image;

FIG. 10 is a front view schematically showing a temperature sensor 5 in an inkjet printing apparatus 1 according to a second preferred embodiment; and

FIG. 11 is a front view schematically showing a temperature sensor 5 in an inkjet printing apparatus 1 according to a third preferred embodiment.

### DESCRIPTION OF THE PREFERRED EMBODIMENTS

Preferred embodiments of the present invention will be described below by referring to the accompanying drawings. To facilitate understanding, the size of each part or the number of such parts in the drawings may be illustrated in an exaggerated manner or a simplified manner in the drawings.

### 1. First Preferred Embodiment

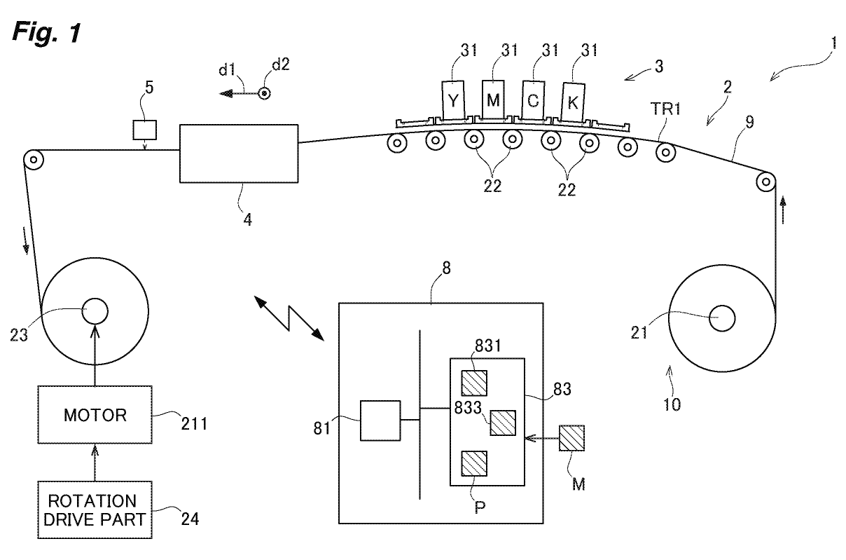

FIG. 1 shows the configuration of an inkjet printing apparatus 1 according to a preferred embodiment. The inkjet printing apparatus 1 is an inkjet-system printer, and records images such as characters, pictures, etc. on a surface of an elongated strip-shaped base material 9 by ejecting droplets of ink from a plurality of head units 31 of an inkjet unit 3 toward the base material 9 while transporting the base material 9. The ink ejected from the head unit 31 is water-based ink. The ink ejected from the head unit 31 is not limited to water-based ink but may be oil-based ink, for example. The base material 9 is continuous paper, for example. However, the base material may be a film or a composite base material composed of a plurality of layers. The composite base material to be used may be prepared by joining release paper and a surface base material to each other with an adhesive, for example.

As shown in FIG. 1, the inkjet printing apparatus 1 includes a transport unit 2, the inkjet unit 3, a drying unit 4, a temperature sensor 5, and a controller 8.

The transport unit 2 includes an unwinding roller 21, a plurality of transport rollers 22, a winding roller 23, and a rotation drive part 24. The unwinding roller 21, the transport rollers 22, and the winding roller 23 are each rotatable about an axis extending in a horizontal direction. A motor 211 is coupled to a rotary shaft of the winding roller 23. The rotation drive part 24 controls the motor 211 to rotate the winding roller 23 about the axis. The rotation drive part 24 may rotate a roller other than the winding roller 23 (some of the transport rollers 22, for example) about the axis.

The base material 9 is wound in a roll shape around the unwinding roller 21. By the rotation of the unwinding roller 21, the base material 9 is fed continuously. All the transport rollers 22 are arranged along a transport path TR of the base material 9. After being fed from the unwinding roller 21, the base material 9 is supported on the predefined transport path TR by the transport rollers 22. After having passed through the transport path TR, the base material 9 is wound in a roll shape around the winding roller 23. In the inkjet printing apparatus 1, the rotation drive part 24 rotates the winding roller 23, thereby transporting the base material 9 in a roll-to-roll system continuously from the unwinding roller 21 toward the winding roller 23.

In the following description, a direction in which the base material 9 is transported by the transport unit 2 is called a “transport direction d1.” In a view from the base material 9 transported by the transport unit 2, a side closer to the winding roller 23 is defined as a downstream side of the transport direction d1, and a side closer to the unwinding roller 21 is defined as an upstream side of the transport direction d1. A horizontal direction perpendicular to the transport direction d1 is called a “width direction d2.”

The inkjet unit 3 includes a plurality of (in this example, four) head units 31. These head units 31 are arranged at intervals in the transport direction d1. The head units 31 eject inks in colors differing from each other (in this example, cyan (C), magenta (M), yellow (Y), and black (K)) to record respective single-color images on a surface of the base material 9. The single-color images in respective different colors are superimposed on each other, thereby forming a multicolor image on an upper surface of the base material 9.

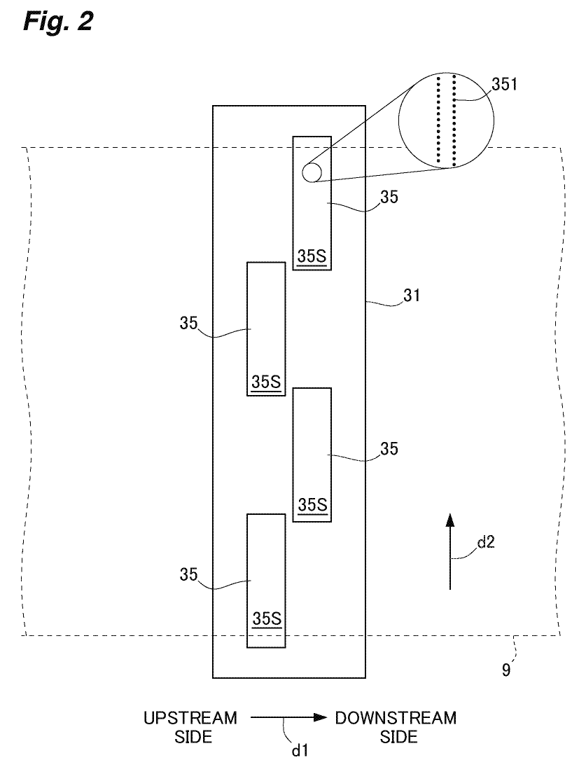

FIG. 2 shows a lower surface of the head unit 31. The head unit 31 includes a plurality of (in this example, four) inkjet heads 35. These inkjet heads 35 are arranged in the width direction d2. In the example shown in FIG. 2, the inkjet heads 35 are arranged in a staggered pattern where the positions of the inkjet heads 35 are shifted from each other in the transport direction d1. The inkjet heads 35 may be arranged in one line extending in the width direction d2.

As shown in FIG. 2, the inkjet head 35 has an ejection surface 35S to face the base material 9. The inkjet head 35 includes a plurality of nozzles 351 provided at the ejection surface 35S and arranged at an uniform interval in the width direction d2. These nozzles 351 are used for ejecting ink. The ink is ejected from the nozzles 351 by a method that may be a piezo method using a piezoelectric element or may be a so-called thermal method of heating the ink using a heater.

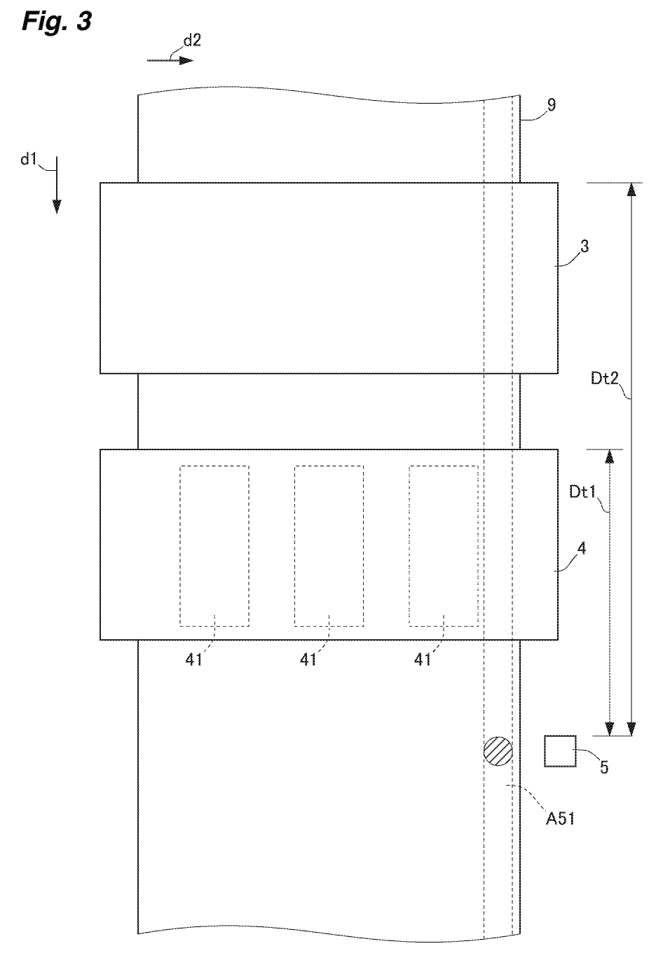

FIG. 3 is a top view schematically showing a part of the inkjet printing apparatus 1. As shown in FIGS. 1 and 3, the drying unit 4 is located on the downstream side of the transport direction d1 with respect to the inkjet unit 3. The drying unit 4 heats the base material 9 having been subjected to printing by the inkjet unit 3 and being transported by the transport unit 2, thereby drying ink applied to the surface of the base material 9. The drying unit 4 includes a plurality of (in this example, three) carbon heaters 41, and dries the ink on the base material 9 by applying an infrared ray from the carbon heater 41 to the base material 9. These carbon heaters 41 extend parallel to the transport direction d1 and are arranged at an uniform interval in the width direction d2. The carbon heaters 41 may extend in a direction (width direction d2, for example) intersecting the transport direction d1. The drying unit 4 may be configured to blow heated dry air to the base material 9 in addition to the configuration of applying an infrared ray.

As shown in FIGS. 1 and 3, the temperature sensor 5 is located on the downstream side of the transport direction d1 with respect to the drying unit 4, and measures a temperature at the base material 9 having been applied with an infrared ray. The temperature sensor 5 is a non-contact radiation thermometer that detects the intensity of an infrared ray emitted from a target. In this preferred embodiment, a measurement target region A51 on the base material 9 available for measurement by the temperature sensor 5 is defined in one end portion of the base material 9 in the width direction d2. The measurement target region A51 has a width (dimension in the width direction d2) that corresponds to the width of a viewing angle of a detector of the temperature sensor 5, for example. The temperature sensor 5 inputs a signal showing a measured temperature to the controller 8. While the temperature sensor 5 is preferably a non-contact sensor, it may be a contact sensor.

Referring back to FIG. 1, the controller 8 is an information processor for controlling each unit of the inkjet printing apparatus 1. The controller 8 includes a processor 81 and a storage part 83. The processor 81 includes a central processing unit (CPU), for example. The storage part 83 includes an auxiliary storage device such as a random access memory (RAM), a read-only memory (ROM), or a hard disk drive. A part of or all the function of the controller 8 may be realized by a hardware circuit such as an application-specific integrated circuit (ASIC).

The storage part 83 stores a computer program P for implementation of a process such as a printing process of performing printing while transporting the base material 9. The controller 8 is a computer program product including the computer program P. The computer program P is provided to the controller 8 via a non-transitory recording medium M. The computer program P is recorded readably in the recording medium M by the controller 8 as a computer. The recording medium M is a semiconductor memory, an optical disk, or a magnetic disk, for example. The computer program P may be provided to the controller 8 via a network.

The storage part 83 stores print data 831 and correlation information 833. The print data 831 is data expressing an image to be printed on the base material 9. In the print data 831, images are managed in units of sheets. One sheet corresponds to one page in a portable document format (PDF) file available as input document data, for example.

Here, data corresponding to one sheet (or one page) expressed by the print data 831 is called image data D61, and an image expressed by the image data D61 is called an objective image 61. The image data D61 is not always required to be data corresponding to one sheet but may be data corresponding to two or more sheets.

The correlation information 833 is information expressing a correlation between the color of an image to be formed by the inkjet unit 3 and infrared absorbance (hereinafter also called “absorbance” simply). The correlation information 833 will be described later in detail.

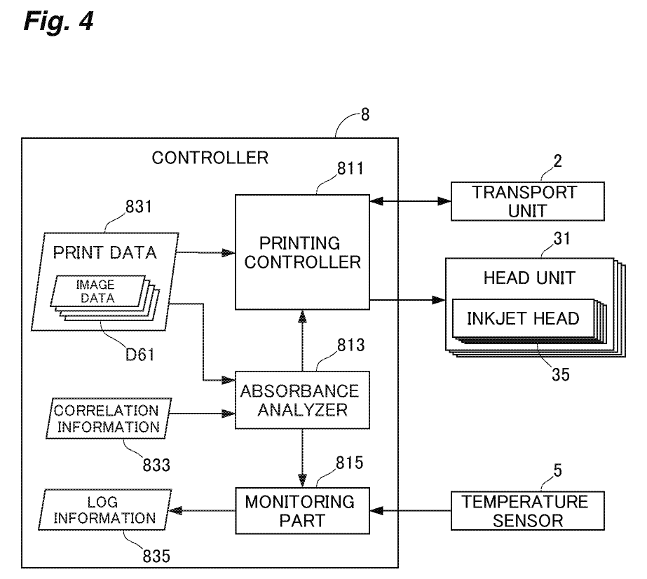

FIG. 4 is a block diagram showing electrical connection between the controller 8 and a control target. The controller 8 functions as a printing controller 811, an absorbance analyzer 813, and a monitoring part 815. These functions are realized by causing the processor 81 to take a procedure defined by the computer program P.

The printing controller 811 performs the printing process by controlling the transport unit 2 and the plurality of head units 31. More specifically, the printing controller 811 controls the transport unit 2 (more particularly, controls the motor 211) to cause the transport unit 2 to transport the base material 9. The printing controller 811 controls each head unit 31 on the basis of the print data 831 to eject ink to the base material 9 from each head unit 31, thereby printing an image. The printing controller 811 may control ejection of the ink from each head unit 31 on the basis of a signal (an output signal from a rotary encoder, for example) showing a transported amount of the base material 9 fed from the transport unit 2.

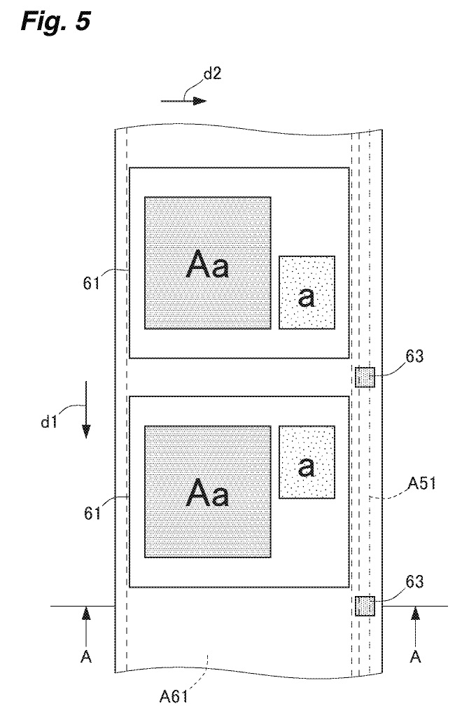

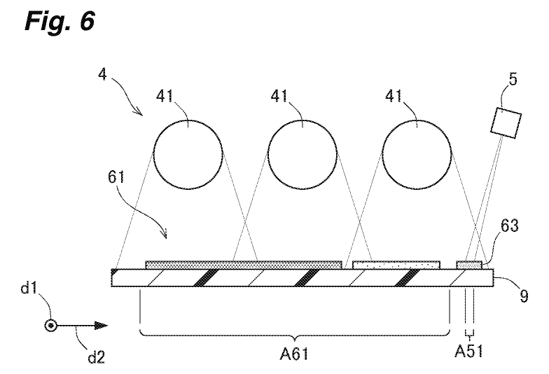

FIG. 5 is a top view schematically showing the base material 9 printed with images. FIG. 6 is a front view schematically showing a section of the base material 9 taken along a position A-A in FIG. 5. The carbon heaters 41 of the drying unit 4 and the temperature sensor 5 are also illustrated in FIG. 6.

As shown in FIG. 5, the printing controller 811 prints a patch image 63 on the base material 9 separately from an objective image 61 expressed by the image data D61. The printing controller 811 prints the patch image 63 on the measurement target region A51 to be subjected to temperature measurement by the temperature sensor 5. As shown in FIG. 6, like the objective image 61, the patch image 63 receives an infrared ray emitted from the carbon heater 41 of the drying unit 4. This causes the temperature sensor 5 to measure a temperature at the patch image 63 having absorbed the infrared ray.

The patch image 63 is an image printed uniformly at a particular ink concentration, for example. The ink concentration means the concentration of each of the C, M, Y, and K inks. The ink concentration is expressed as a dot area coverage showing the ratio of an area covered by dots in terms of percent (percentage), for example.

As shown in FIG. 5, in this example, the patch image 63 is printed between two objective images 61 next to each other in the transport direction d1. The patch image 63 has a length (dimension in the transport direction d1) sufficiently smaller than the length of the objective image 61. In the example shown in FIG. 5, the length of the patch image 63 is smaller than an interval between the two objective images 61 next to each other in the transport direction d1. The patch image 63 may be printed in a position next to the objective image 61 in the width direction d2 (a position between an upstream end and a downstream end of the objective image 61).

In order for the temperature sensor 5 to measure a temperature at the patch image 63 with high accuracy, it is desirable that staying time when the patch image 63 stays within a viewing angle of the detector of the temperature sensor 5 be longer than response time of the temperature sensor 5. This staying time is proportional to the length of the patch image 63 and inversely proportional to a speed at which the base material 9 is transported by the transport unit 2. For this reason, the length of the patch image 63 is set so as to be proportional to the transport speed. Specifically, the patch image 63 may be lengthened further in response to increase in the transport speed, and the patch image 63 may be shortened further in response to reduction in the transport speed.

While the width of the patch image 63 (dimension in the width direction d2) is not particularly limited, it is equal to or greater than the width of the measurement target region A51 for the temperature sensor 5. The patch image 63 is printed in such a way as to project from the measurement target region A51 to the opposite sides of the width direction D2.

Referring back to FIG. 4, using the correlation information 833, the absorbance analyzer 813 performs a process of analyzing infrared absorbance expressed by the image data D61. More specifically, the absorbance analyzer 813 performs a process of identifying a maximum value of the infrared absorbance expressed by the image data D61 (maximum absorbance). The absorbance analyzer 813 transfers information to the printing controller 811 that is about a color resulting in infrared absorbance equal to or greater than the identified maximum absorbance. This causes the printing controller 811 to print the patch image 63 on the basis of the received color information.

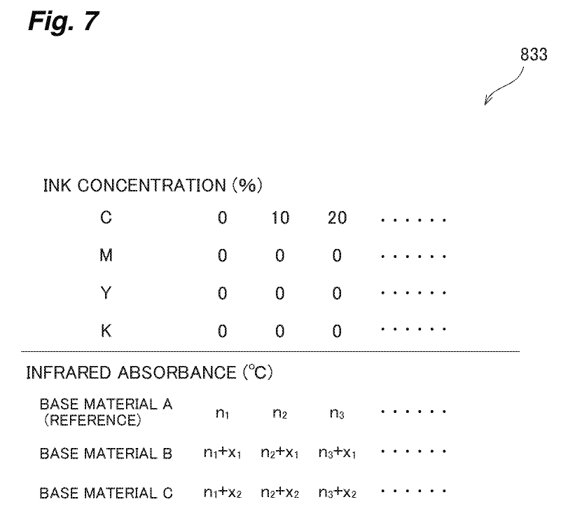

FIG. 7 conceptually shows an example of the correlation information 833 showing a correlation between an ink color and absorbance. According to the correlation information 833, information showing an ink color is defined as the concentration of each of the C, M, Y, and K inks. Regarding the infrared absorbance, with a part printed with an ink of a correlating concentration named as a printed portion, the infrared absorbance is defined as a temperature at the printed portion having absorbed an infrared ray (hereinafter called an “absorption temperature”).

The absorption temperature may be an actually measured value. As an example, the inkjet unit 3 may perform printing at the concentration of each of the C, M, Y, and K inks changed stepwise in the inkjet printing apparatus 1, and a resultant printed portion may be dried by the drying unit 4 and then subjected to measurement by the temperature sensor 5. The absorption temperature may be acquired using a printing apparatus other than the inkjet printing apparatus 1.

The correlation information 833 shown in FIG. 7 contains respective absorption temperatures at several types of base materials 9 (here, base materials A, B, and C). In this example, with respect to the base material A as a reference, the absorption temperatures at the base materials B and C are obtained by adding +x₁ and +x₂ respectively to the absorption temperature (n₁, n₂, …) at the base material A. Each of +x₁ and +x₂ shows a temperature responsive to the characteristics of the base material B or the base material C (infrared absorbing characteristics) with respect to the base material A. The absorbance analyzer 813 refers to an absorption temperature at a base material of a type responsive to the base material 9 to be used actually. The infrared absorbance is not limited to the absorption temperature such as that shown in FIG. 7. As long as the infrared absorbance is information showing a degree of absorption of an infrared ray, it may be defined as an infrared absorption ratio, for example.

The absorbance analyzer 813 divides the objective image 61 expressed by the image data D61 into a plurality of unit regions in the transport direction d1 and the width direction d2, and acquires absorbance correlating to a representative value of an ink concentration in each of the resultant unit regions from the correlation information 833. The representative value is an average value or a median value, for example. Furthermore, the absorbance analyzer 813 identifies maximum absorbance from the absorbance in each of the unit regions, and transfers an ink concentration resulting in the identified maximum absorbance or absorbance greater than the maximum absorbance to the printing controller 811. This causes the printing controller 811 to print the patch image 63 at the transferred ink concentration onto a position corresponding to the objective image 61.

The absorbance analyzer 813 identifies the maximum absorbance before the inkjet unit 3 prints the objective image 61 expressed by the target image data D61, for example. This allows the patch image 63 to be printed on the upstream side with respect to the objective image 61. The maximum absorbance may be identified before printing targeted for print data is started. In this case, print data may be generated in such a way as to include patch image data expressing the patch image 63.

Referring back to FIG. 4, the monitoring part 815 monitors a measured temperature showing measurement result from the temperature sensor 5. Specifically, the monitoring part 815 monitors a measured temperature at the patch image 63 measured by the temperature sensor 5. As an example, the monitoring part 815 judges whether the measured temperature has exceeded a predefined threshold temperature defined as a high-temperature anomaly. Then, the measured temperature may be recorded in log information 835 showing judgment result. The threshold temperature may be a heatproof temperature set in advance for each type (A, B, C) of the base material 9, or may be set lower than the heatproof temperature, for example.

If a measured temperature at the particular patch image 63 has exceeded the threshold temperature, a high-temperature anomaly might also occur at the objective image 61 corresponding to the particular patch image 63. In response to this, by causing the monitoring part 815 to generate the log information 835, a user is allowed to easily grasp the objective image 61 (sheet) from the log information 835 where a high-temperature anomaly might have occurred.

If the monitoring part 815 detects a high-temperature anomaly, the monitoring part 815 may make an announcement to the outside via a predetermined output device for announcing information for identifying the objective image 61 (identification information about a sheet, for example) corresponding to the patch image 63 where the high-temperature anomaly has been detected. The output device to be used may be a display, a printer, or the like. If the monitoring part 815 detects the high-temperature anomaly, a mark showing the high-temperature anomaly may be given to the objective image 61 on the base material 9 where the high-temperature anomaly has been detected or to an area around this objective image 61. This mark may be given by an inspection device (not shown in the drawings) to inspect printed result about the base material 9, for example.

If the patch image 63 is printed on the upstream side with respect to the corresponding objective image 61, it is possible to detect a high-temperature anomaly at the patch image 63 before a high-temperature anomaly occurs at the objective image 61. Thus, it is possible to take action so as not to cause a high-temperature anomaly.

In order to avoid a high-temperature anomaly, the monitoring part 815 may control the quantity of an infrared ray to be emitted from the carbon heater 41 of the drying unit 4 in response to a measured temperature. As an example, if a measured temperature at the patch image 63 has exceeded a predetermined upper limit, the monitoring part 815 may perform control of reducing power of the carbon heater 41. If a measured temperature at the patch image 63 has exceeded a predetermined lower limit, the monitoring part 815 may perform control of increasing power of the carbon heater 41. If the monitoring part 815 detects a high-temperature anomaly at the patch image 63, the monitoring part 815 may stop the printing process by stopping the motions of the transport unit 2 and the inkjet unit 3.

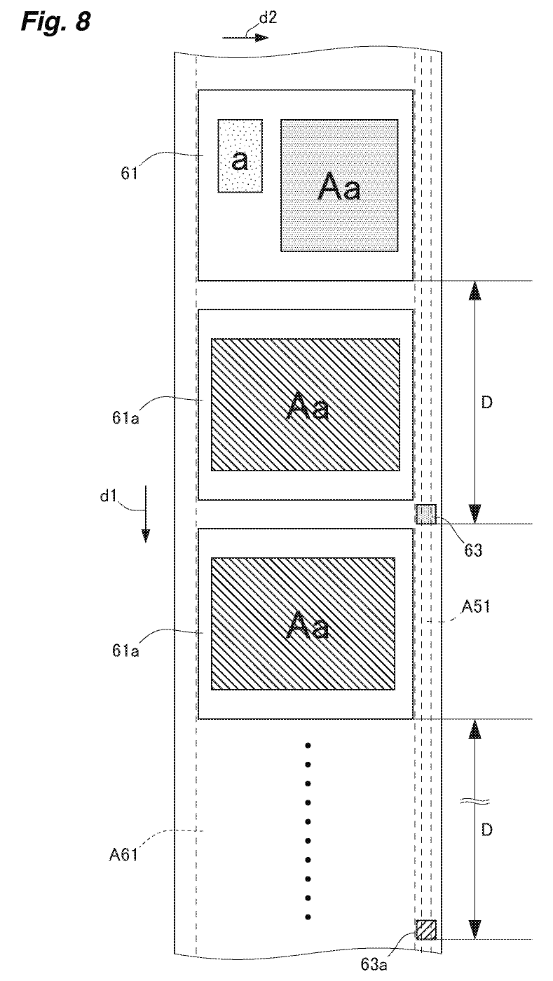

FIG. 8 is a view for explaining exemplary setting of a distance between the objective image 61 and the patch image 63. In order for the monitoring part 815 to take action properly (such as reducing power of the carbon heater 41 or stopping the printing process) in response to a high-temperature anomaly, a separation distance D in the transport direction d1 between the objective image 61 and the patch image 63 may be set sufficiently larger than a distance by which the base material 9 is to be transported before the action is taken.

For example, the separation distance D may be set larger than a distance Dt1 (see FIG. 3) in the transport direction d1 from an entrance (upstream end) of the drying unit 4 to a measurement position for the temperature sensor 5. This allows a high-temperature anomaly at the patch image 63 to be detected before drying of the objective image 61, making it possible to avoid a high-temperature anomaly at a printed portion of the objective image 61 effectively. The separation distance D may be set larger than a distance Dt2 (see FIG. 3) from an entrance (upstream end) of the inkjet unit 3 to a detection position for the temperature sensor 5. This allows a high-temperature anomaly at the patch image 63 to be detected before printing of the objective image 61, making it possible to avoid a high-temperature anomaly at a printed portion of the objective image 61 more effectively.

It is not essential to set a plurality of the separation distances D uniformly. If the print data 831 includes several types of the image data D61, for example, several types of objective images 61 and 61a are printed and several types of patch images 63, 63a corresponding to these objective images are printed, as shown in FIG. 8. In this case, the separation distance D between the objective image 61 and the patch image 63 and the distance D between the objective image 61a and the patch image 63a are not always required to be equal to each other but may be different from each other.

As described above, in the inkjet printing apparatus 1, the patch image 63 is printed at an ink concentration of an emissivity resulting in the maximum absorbance in the objective image 61 or absorbance greater than the maximum absorbance, and a temperature at the printed patch image 63 is measured. In this case, a maximum temperature at the objective image 61 assumed to be reached through application of an infrared ray is, in principle, equal to or less than a measured temperature at the patch image 63. Thus, by monitoring the measured temperature at the patch image 63, it becomes possible to predict a high-temperature anomaly properly at a printed portion of the objective image 61

In particular, by printing the patch image 63 in a color resulting in the maximum absorbance in the objective image 61, it becomes possible to make a measured temperature at the patch image 63 as close as possible to a maximum temperature assumed to be actually reached at a printed portion of the objective image 61. This allows reduction in false detection of a high-temperature anomaly at the printed portion of the objective image 61.

It is not essential to print the patch image 63 having the maximum expressed by the image data D61 or absorbance having a greater value than the maximum absorbance. However, in order to evaluate a maximum temperature with high accuracy assumed to be reached at the objective image 61 through receipt of application of an infrared ray, it is desirable for the printing controller 811 to print the patch image 63 at an ink concentration at which absorbance in the patch image 63 becomes greater than an average value of absorbance (average absorbance) expressed by the image data D61. In this case, the absorbance analyzer 813 may calculate the average absorbance expressed by the image data D61. By measuring a temperature at the patch image 63 printed in a color resulting in absorbance greater than the average absorbance, a temperature at a site of the objective image 61 likely to be placed under a high temperature can be measured using the patch image 63. This makes it possible to detect a high-temperature anomaly at a printed portion of the objective image 61 properly.

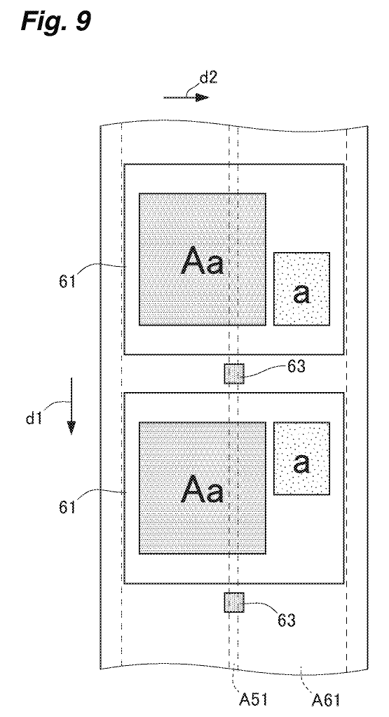

FIG. 9 is a top view showing a modification of a print position for the patch image 63. In the example shown in FIGS. 5 and 6, the patch image 63 is printed outside a print region A61 for the objective image 61 (in one end portion of the base material 9) in the width direction d2. Meanwhile, as shown in FIG. 9, the patch image 63 may be printed inside the print region A61 in the width direction d2. In this case, the measurement target region A51 for the temperature sensor 5 is also set inside the print region A61 in conformity with the print position for the patch image 63.

As shown in FIG. 6, in the presence of the plurality of carbon heaters 41 each extending in the transport direction d1 and arranged in the width direction d2, the quantity of a received infrared ray might become smaller in the vicinity of an end portion of the base material 9 in the drying unit 4 than in the vicinity of the center of the base material 9. In this case, by setting a print position for the patch image 63 inside the print region A61 as shown in FIG. 9, it becomes possible to make the quantity of an infrared ray received at the patch images 63 approximate to the quantity of an infrared ray received at the objective image 61. As a result, it is possible to detect a high-temperature anomaly at the objective image 61 more properly by monitoring a measured temperature at the patch image 63.

### 2. Second Preferred Embodiment

A second preferred embodiment will be described next. In the following, an element having a function comparable to that of an element already described may be given the same reference sign or a reference sign with an additional alphabetic character, and detailed description thereof may be omitted.

In the first preferred embodiment, the absorbance analyzer 813 calculates maximum absorbance (or average absorbance) expressed by the image data D61 by analyzing infrared absorbance in the image data D61, and determines a color (ink concentration) of the patch image 63 in response to the calculated absorbance. However, it is not essential to determine the color of the patch image 63 in response to the absorbance in the image data D61.

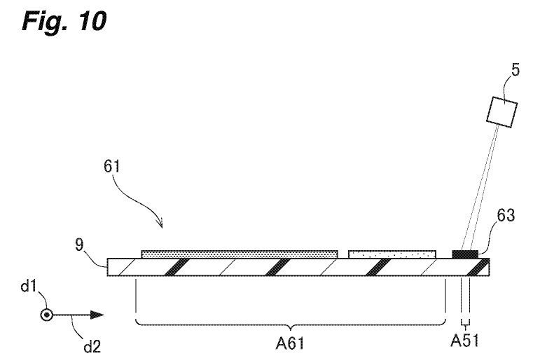

FIG. 10 schematically shows the temperature sensor 5 in the inkjet printing apparatus 1 according to a second preferred embodiment. In this preferred embodiment, the printing controller 811 controls the inkjet unit 3 to print the patch image 63 in black (K 100%). Black generally results in the highest infrared absorbance. Thus, monitoring a measured temperature at the patch image 63 in black allows a high-temperature anomaly at a printed portion of the objective image 61 to be predicted reliably.

Printing the patch image 63 only in black achieves omission of the absorbance analyzer 813 and the correlation information 833. Thus, it is possible to reduce processing burden on the controller 8.

### 3. Third Preferred Embodiment

In the first and second preferred embodiments, the patch image 63 is printed in the measurement target region A51 for the temperature sensor 5 fixed at a determined position, and a high-temperature anomaly at a printed portion of the objective image 61 is detected on the basis of a measured temperature at the patch image 63. However, a temperature may be measured at the objective image 61 instead of measuring a temperature at the patch image 63.

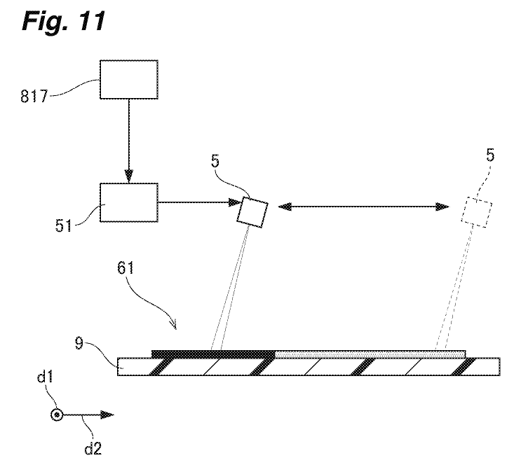

FIG. 11 is a front view schematically showing the temperature sensor 5 in the inkjet printing apparatus 1 according to a third preferred embodiment. As shown in FIG. 11, the inkjet printing apparatus 1 of this preferred embodiment further includes a sensor mover 51 and a moving controller 817. The sensor mover 51 is a mechanism for moving the temperature sensor 5 in the width direction d2. The sensor mover 51 includes a linear drive mechanism such as a ball screw mechanism or a linear motor mechanism. The moving controller 817 is a function realized by the processor 81 of the controller 80.

The moving controller 817 controls the sensor mover 51 to move the temperature sensor 5 in the width direction d2 in such a way as to cause the temperature sensor 5 to measure a temperature at a portion of the objective image 61 expressed by the image data D61 where absorbance becomes maximum absorbance (or becomes absorbance greater than average absorbance in the objective image 61). The maximum absorbance in the objective image 61 is identified by the absorbance analyzer 813.

According to this preferred embodiment, a temperature at the objective image 61 is measured directly instead of measuring a temperature at the patch image 63. This allows a high-temperature anomaly to be detected directly at a portion printed with the objective image 61.

### 4. Modifications

While the preferred embodiments have been described above, the present invention is not limited to the above-described embodiments but can be changed in various ways.

For example, it is not essential to print the patch images 63 corresponding to a plurality of the objective images 61 contained in one print data 831 but only the patch images 63 corresponding to some of the objective images 61 may be printed.

Two or more patch images 63 may be formed in response to one objective image 61. For example, the objective image 61 may be divided into a plurality of regions in the transport direction d1, and the corresponding patch image 63 may be formed in response to each of the regions.

In the above preferred embodiments, the correlation information 833 is table information defining a particular ink concentration and correlating absorbance. Alternatively, the correlation information 833 may be a functional formula for calculating absorbance in response to input of an ink concentration.

While the invention has been shown and described in detail, the foregoing description is in all aspects illustrative and not restrictive. It is therefore understood that numerous modifications and variations can be devised without departing from the scope of the invention. The structures described in each of the above preferred embodiments and each of the modifications may be consistently combined together or omitted, as appropriate.

What is claimed is:

1. An inkjet printing apparatus comprising:
a transport unit that transports a base material in a transport direction;
an inkjet unit that ejects inks in a plurality of colors to said base material being transported by said transport unit;
a printing controller that controls said inkjet unit on the basis of image data to print an objective image expressed by said image data on said base material;
a drying unit located on a downstream side of said transport direction with respect to said inkjet unit, the drying unit applying an infrared ray to said base material to dry an ink ejected to said base material;
a temperature sensor that measures a temperature at a measurement target region in said base material applied with said infrared ray; and
a monitoring part that monitors the temperature at said measurement target region measured by said temperature sensor, wherein
said measurement target region for said temperature sensor has infrared absorbance greater than an average value of infrared absorbance expressed by said image data.

2. The inkjet printing apparatus according to claim 1, wherein
said printing controller controls said inkjet unit to print a patch image in said measurement target region, the patch image being an image where infrared absorbance is greater than the average value of the infrared absorbance expressed by said image data, and
said temperature sensor measures a temperature at said measurement target region defined in said base material and printed with said patch image.

3. The inkjet printing apparatus according to claim 2, wherein
said printing controller controls said inkjet unit to print said patch image using a color resulting in infrared absorbance equal to or greater than a maximum value of the infrared absorbance expressed by said image data.

4. The inkjet printing apparatus according to claim 2, further comprising:
a storage part storing correlation information showing a correlation between ink concentrations in said plurality of colors and infrared absorbance; and
an absorbance analyzer that analyzes the infrared absorbance expressed by said image data using said correlation information.

5. The inkjet printing apparatus according to claim 2, wherein
said printing controller prints said patch image in black in said measurement target region.

6. The inkjet printing apparatus according to claim 2, wherein
said printing controller controls said inkjet unit to print said patch image on an upstream side of said transport direction with respect to said objective image.

7. The inkjet printing apparatus according to claim 1, further comprising:
a sensor mover that moves said temperature sensor in a width direction in such a way as to cause said temperature sensor to measure a temperature at a portion of said objective image expressed by said image data where infrared absorbance is greater than the average value of the infrared absorbance.
